(19) United States
(12) Patent Application Publication
(10) Pub. No.: US 2009/0063538 A1
(43) Pub. Date: Mar. 5, 2009

(54) METHOD FOR NORMALIZING DYNAMIC URLS OF WEB PAGES THROUGH HIERARCHICAL ORGANIZATION OF URLS FROM A WEB SITE

(76) Inventors: Krishna Prasad CHITRAPURA, Bangalore (IN); Anandsudhakar Kesari, Bangalore (IN); Alok Kirpal, Bangalore (IN); Mahesh Tiyyagura, Hyderabad (IN)

Correspondence Address: HICKMAN PALERMO TRUONG & BECKER, LLP, 2055 GATEWAY PLACE, SUITE 550, SAN JOSE, CA, 95110, US

(21) Appl. No.: 11/847,989

(22) Filed: Aug. 30, 2007

(51) Int. Cl. G06F 17/30

(52) U.S. Cl. 707/102; 707/E17.009; 707/E17.107

(57) ABSTRACT

Techniques are described for normalizing dynamic URLs using a hierarchical organization of a web site. Given web pages associated with a web site, an information extraction method is used to generate data structures that represent the content or structure of each of the web pages. These data structures are appended to the corresponding dynamic URLs. The modified URLs with the data structures are tokenized with the resulting tokens clustered to create a hierarchical organization. Nodes of the hierarchical organization may be merged based upon occurrence or patterns of content and structure. The merged hierarchical organization may then be pruned to remove irrelevant information and to reduce the memory footprint of the hierarchical organization. When a new dynamic URL is received, the new dynamic URL is matched to the hierarchical organization. Important parameters are taken into account and irrelevant information may be removed. Based upon the matching to the hierarchical organization, a normalized URL is returned.

### CROSS REFERENCE TO RELATED APPLICATIONS

This application is related to U.S. patent application Ser. No. 11/481,734, filed on Jul. 5, 2006, entitled “TECHNIQUES FOR CLUSTERING STRUCTURALLY SIMILAR WEB PAGES” which is incorporated by reference in its entirety for all purposes as if originally set forth herein.

### FIELD OF THE INVENTION

The present invention relates to web page URLs, and specifically, normalizing dynamic URLs of web pages using hierarchical organizations from a web site.

### BACKGROUND

The URL for a web page may be dynamic or static. A dynamic URL is a page address that results from the search of a database-driven web site or the URL of a web site that runs a script. This contrasts with static URLs, in which the contents of the web page remain the same unless changes are hard-coded into the HTML.

Many web sites utilize dynamic URLs in order to display content. A dynamic URL is generated by web servers to refer to web pages that depend on parameters. The content of a web page may vary based on the values and presence of certain parameters. Thus, some parameters may not have any effect on the content of the web page. Parameters may be user-defined or environmental. Environmental parameters may include, but are not limited to, the current time and the location of the user. User-defined parameters are parameters customized for a particular website.

A dynamic URL comprises a static component, a script name, and parameters. The parameters are encoded as keys and values and are separated by ampersands. An example of a dynamic URL is:
http://shopping.foo.com/product.php?cat=“electronics”&prod_id=“13”&session_id=“daef”

In this example, the static portion of the URL is “http://shopping.foo.com/” and the script name is “product.php.” The parameters, which begin after the “?” in the example, are “cat=‘electronics,’” “product_id=‘13,’” and “session_id=‘deaf.’” For the first parameter, “cat” is the key and “electronics” is the value. For the second parameter, “product_id” is the key and “13” is the value. Finally, the key for the third parameter is “session_id” and the value is “deaf.”

Mining information from the web in the form of automatically extracting information and searching are heavily affected by the presence of the dynamic URLs because web pages retrieved with dynamic URLs may have different URLs for the web page with the same content. For example, the parameters in the URL may be re-arranged. Focusing on the example above, the parameter key “prod_id” appears before the parameter key “session_id.” If the parameters were to be re-arranged such that the “session_id” parameter appeared before “prod_id,” then the URL would be different, but the displayed web page would have the same content.

Other circumstances may also result in different dynamic URLs for a web page of the same content. Some of the parameters may vary, such as “session_id,” but result in a web page with the same content. For example, the parameter “session_id” may have different values for each user of a web site. However, even though “session_id” has different values, the content of the web page remains the same.

In yet another example, many websites convert dynamic URLs to static URLs through a method called “URL rewriting.” In URL rewriting, an application in a web server called a “rewrite engine” modifies a dynamic URL to a static URL before delivery of the web page to a user. URL rewriting might be performed so that URLs that pass data to a web server (a dynamic URL) are in one form, and URLs that are shown to a user (the static URL) appear in a more user-friendly form. However, tokens of rewritten static URLs may vary, but display web pages with the same content. Thus, in this circumstance, the same problem is encountered of varied URLs with the same content located in the web document.

In addition, optional parameters may alter the placement of the content of the web page. For example, a dynamic URL web page might contain a list of items. The dynamic URL web page might add the parameter “sort_by,” which sorts the list according to some defined category. The dynamic URL without the parameter “sort_by” might contain the same content as the dynamic URL web page with the parameter “sort_by,” but place the contents in a different order. Web sites may also display a web page with the same or similar content with the web page retrievable using either a dynamic URL or a static URL. Another factor is that some parameters rarely occur in a web site and so keeping track of these parameters would involve unnecessary overhead.

This information is important to search applications because a web page with the same content, as a result of dynamic and differing URLs, may be extracted multiple times. Search, data mining, and ad placement in a web page would be improved if dynamic and different URLs were better identified with the content of the web page.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a hierarchical organization of a web site, according to an embodiment of the invention;

FIG. 2 is a diagram of a cluster name, according to an embodiment of the invention;

FIGS. 3A and 3B is a flowchart diagram of an algorithm to match the static component of dynamic URLs, according to an embodiment of the invention;

FIGS. 4A and 4B is a flowchart diagram of an algorithm to match the dynamic component of dynamic URLs, according to an embodiment of the invention;

FIG. 5 is a flowchart diagram of a technique to normalize dynamic URLs using hierarchical organizations of a web site, according to an embodiment of the invention;

FIG. 6 is a diagram of a hierarchical organization of a web site, according to an embodiment of the invention; and

FIG. 7 is a block diagram of a computer system on which embodiments of the invention may be implemented.

### DETAILED DESCRIPTION

Techniques are described to normalize, or bring in to canonical form, dynamic URLs using a hierarchical organization of a web site. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A web page retrieved using dynamic URLs may contain the same content regardless of which of the many different dynamic URLs was used to retrieve that web page. Normalizing or converting the dynamic URLs by removing information that is not relevant to the content is beneficial for search, data mining, and ad placement in the web page. Prioritizing the importance of parameters that do affect content is also beneficial. By normalizing web pages, the probability that a web page with the same content and different dynamic URLs will be extracted multiple times is decreased. URL normalization finds a representative string, called the normalized URL, that identifies all the static and dynamic URLs from the same web server that display the same content.

Web search is benefited by decreasing the overhead necessary to retrieve information from a web page, placing relevant advertisements on suitable web pages, and performing more efficient web crawling on the Internet. Previously in search, dynamic URLs were not well represented because of the difficulty in categorizing many different URLs that have the same or similar contents. A normalization scheme helps to rank the results better. In online offer placement on web pages, normalizing a new web page improves the categorizing of the subject matter of the web page in order to place more relevant advertisements. Finally, grouping similar pages together and extracting content information that pertains to the groups makes web crawling much more efficient.

The method and technique of normalizing URLs may be performed under varying circumstances. In one embodiment, if there are two web pages with dynamic URLs, then their URLs may be used to determine their similarities. In another embodiment, a previously unknown URL may be matched to the closest URL previously encountered and then a normalized form of the unknown URL may be returned.

Using the complete content of web pages to normalize URLs would be slow and not scalable with the vast amount of web pages available on the Internet. To decrease the overhead that would result if only the content of the web pages were used, methods are described that use a fingerprint of the content of the web page. Then an automated method is used to determine the normalized or canonical form of the URL.

### Creating a Hierarchical Organization of the Static Component of the URL

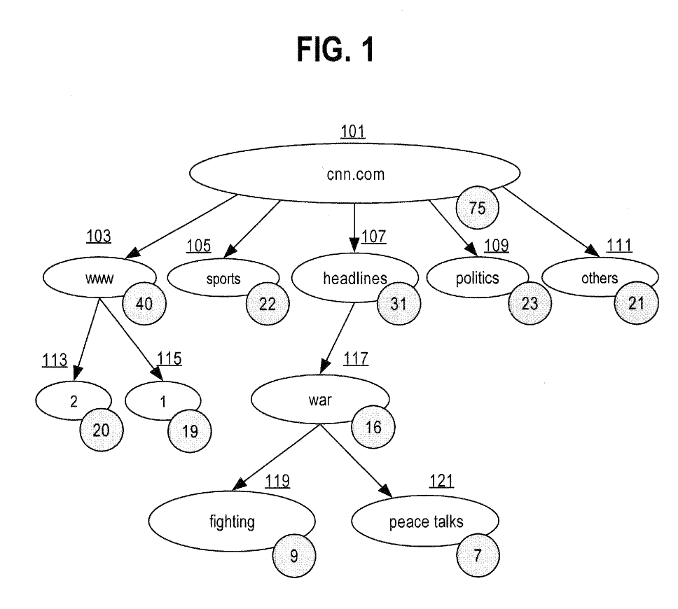

In an embodiment, a hierarchical organization of web page URLs, herein referred to as a site-map, is made with each node in the hierarchy representing a token. An example of this is shown in FIG. 1. A token in a node co-occurs with tokens in that node's parent and children. Tokens higher up on the hierarchy occur more frequently than those below. This is seen in FIG. 1 as the domain, cnn.com 101, occurs more frequently, or in 75 URLs as shown in the grey circle connected to the node, than headlines 107, which is lower on the hierarchy and occurs in 31 URLs. Each node comprises information such as, but not limited to, the number of URLs and the list of URLs belonging to that node. A URL is said to belong to a node if the URL contains the token defined at that node.

In an embodiment, the hierarchical organization places sub-domains at a lower level than domains, and hostnames at a lower level than domain names. For example, in FIG. 1, the various sections in the website cnn.com such as sports 105, headlines 107, and politics 109, are clustered one level lower than the domain cnn.com 101. The hierarchical organization has multiple levels. On a level below headlines 107, is war 117 that is in 16 URLs. On the level below war 117, is fighting 119 and peace talks 121. As fighting 119 and peace talks 121 are a level below war 117, these tokens occur less frequently in URLs than war 117, with peace talks in 7 URLs and war in 9 URLs.

The static component of the URL is first tokenized based on various separators that may include, but are not limited to, the symbols “/” and “&.” The tokens of the static component of the URL are clustered in such a way that the order of the directory is retained. Directories with low support, or having a low occurrence in the website, are clustered into another category named “others”. As used herein, “support” of a token in the URL is the minimum number of URLs from that web site that have the same token. For example, for the website, cnn.com 101, clusters may be formed for sports 105, headlines 107, and politics 109, because they are contained in a lot of URLs. Other URLs, such as “http://cnn.com/contacts,” “http://cnn.com/feedback,” and “http://cnn.com/about-us” are clustered into others 111 because they occur as singletons.

The sub-domain name, hostname, and directories are tokenized on dynamic delimiters and clustered in cases where there is adequate support. For example, as seen in FIG. 1, if a domain has hosts “www1.cnn.com” and “www2.cnn.com,” then the hostname is tokenized as “www,” “1,” and “www,” “2.” The hostnames are retained as “www” 103, “1” 115, and “2” 113, as nodes in the cluster hierarchy because there is adequate support for the nodes.

As another example, the URL:
“http://shopping.yahoo.com/product/item_sku2345/”
   is tokenized and rearranged as “yahoo.com,” “shopping,” “product,” “item,” “sku,” and “2345.”

In an embodiment, an algorithm for clustering the static component of URLs is called. The algorithm is called with the function name “ClusterStatic ({URLs}, Level)” with the arguments, “{URLs}” comprising the set of URLs, and “Level” indicating the level of the static URL. First, a particular token is selected that where the token has the most support in the given set of “{URLs}.” Next, URLs containing the token at the particular level are grouped together under the particular token. If the level is the last level of the static component of the URL, then the function returns with the groups of URLs under the particular tokens. Otherwise, the “ClusterStatic” function is called recursively. Under this circumstance, the function is called as “ClusterStatic ({URLs containing token at the current level }, Level +1).” For the arguments in the recursive function, the set of URLs included in this function call are the URLs that contain the particular token at the current level and “Level” is incremented by one. The set of URLs, or “{URLs},” in the original function is then reduced by the URLs containing the particular token at the current level. The first step of selecting a particular token with the most support in the given set of “{URLs}” and the step of calling the “ClusterStatic” function recursively are repeated until “{URL}” is a “NULL” set, or the number of URLs in “{URLs}” is below the support threshold. If the number of URLs in the set of URLs is below the support threshold, the remaining URLs are grouped under a special token “others.” In another embodiment, other algorithms may be implemented in which static components of URLs are clustered.

### Fingerprinting and Shingles to Find Similarity

In an embodiment, to create the hierarchical organization of the web pages, the contents or structure of the web pages are fingerprinted. If the entire contents of the HTML of a web page were used to find similarities, then the overhead required to catalog these web pages would be enormous. Fingerprinting greatly lessens the overhead and is very accurate for determining similarities. As used herein, fingerprinting refers to any information extraction method or feature generation method to generate data structures, or “fingerprints,” that represent the content of a web page. In an embodiment, these fingerprints are created by using shingling. These fingerprints are then appended as parameters to the dynamic URLs in order to create modified URLs, with these fingerprints used to account for the content or structure of the web page. These modified URLs are then clustered into the hierarchical organization called a site-map.

In an embodiment, shingles are computed using a specified number of orthogonal hashes. The shingles may be computed based on the complete HTML page, the de-tagged text of the HTML page, or on the distinct text in the HTML, such as title, large font, bold, or anchor text. The decision of what to compute depends on the necessary accuracy of the normalization detection and the availability of computing power. The minimum hash values of each of the shingles are recorded. Then, a specified byte length of the shingles is added as parameters and values to the URLs. For example, the parameter for a shingle may have the key “sh₁” and the value of the parameter may be the shingle value. The number of shingles may vary such that the second shingle has the key “sh₂” and the nth shingle has the key “shₙ”.

Because these shingles are generated from the specified independent hash functions, the approximate similarity between any two documents may be computed by performing a direct comparison amongst the shingles. Comparing shingles to discover the similarity between content is further described in U.S. Pat. No. 6,119,124, entitled “Method for Clustering Closely Resembling Data Objects” by Andrei Broder, Steve Glassman, Greg Nelson, Mark Manasse, and Geoffrey Zweig, which is incorporated by reference herein.

In an embodiment, the shingles may be grouped together to form a single parameter. If there are eight shingles being stored, then rather than storing each shingle as a parameter and having eight separate parameters, the shingles are grouped into a single parameter if their values match. In another embodiment, the shingles are grouped together if a specified number of the shingles match. This varies the level of similarity required to create a match. For example, in one embodiment, if seven out of the eight shingles match, then the shingles are grouped into a single parameter. The same shingles also do not need to match in every instance. One of the shingles may be masked so that if any seven shingles from one URL match any seven shingles from another URL, they form a single parameter. In this example, each shingle may also be a parameter, but grouping shingles together to form a single parameter makes normalizing the URLs a much simpler task.

### Clustering and Pruning

In an embodiment, the dynamic components of the URL, with the shingles appended to the URL, are rearranged and clustered, with the parameters as levels and with values as the splitting criteria. Thus, parameters with more support of occurrence and low variance in value are clustered at a higher level node than parameters with low support and high variance in those parameters' values. This provides a method for determining the importance of each parameter in a dynamic URL.

In an embodiment, the dynamic components of the URL may be implemented using a function “ClusterDynamic ({URLs})” with the argument “{URLs}”, indicating a first set of URLs to be clustered. First, a particular parameter key is selected that has the highest support among URLs and lowest variance in values assigned to the parameter key. Next, URLs containing the particular parameter key are grouped under the particular parameter key. Then, the values for the particular parameter key are grouped together. For each of the values, a token of the values is selected that has the most support from URLs containing the particular parameter key. URLs containing the value token are then grouped under the value token. The grouped URLs with the value token are then removed from the set of URLs with the particular parameter key. The steps of selecting a value token with the highest support, grouping the URLs with the value token, and removing URLs with the value token from the set of URLs with the parameter key is repeated until the set of URLs is “NULL” or the number of URLs in the set is less than the support threshold. If the number of URLs in the set of URLs is below the support threshold, the remaining URLs are grouped under a special token, “others.”

When all URLs under the particular parameter key are grouped by value or “others,” then the URLs containing the parameter key are removed from the first set of “{URLs}.” The function, “ClusterDynamic ({remaining URLs}),” is then called recursively, with the URLs remaining in the first set. This algorithm is continued until the first set is “NULL” or the number of URLs in the first set is less than the support threshold. If the number of URLs in the first set is less than the support threshold, then the remaining URLs are grouped under a special token “others.” In another embodiment, other algorithms may be implemented in which dynamic components of URLs are clustered.

Pruning the site map removes nodes that do not determine or influence the content of the web page. In one embodiment, nodes clustered below “shingle nodes,” or those nodes containing the shingles as parameters, are removed. If URLs are associated with the same shingle node, then these associated URLs have similar content. Parameters a level below the shingle node have little relevance to the content of the web page and may be removed. Removing irrelevant parameters, or parameters that do not alter the behavior of the web server that serves the page, helps reduce the memory foot print of the hierarchical organization.

The hierarchical organization, also referred to herein as a cluster tree (obtained after clustering), may have different shapes, such as a large fan-out or a large height, depending on how the URLs are structured in a website. The cluster tree may be pruned to achieve a desired level of detail. Pruning helps achieve a reduction in the memory foot print of the cluster tree and makes searches of the tree faster. In addition, irrelevant URL parameters and values are identified and discarded. This leads to structurally dominant or content-wise dominant clusters. Parameters with low support do not significantly impact the end application (eg., search, online relevant advertisements placement, and information retrieval).

In an embodiment, pruning is performed by traversing the cluster tree from its root and identifying nodes to merge. Nodes are merged if they are found to be similar based upon various criteria. In support-based merging, clusters with lower support are merged with their siblings to obtain higher occurrence clusters. In pattern-based merging, URLs of web pages with similar HTML content and structure are merged into a cluster. Nodes may also be merged based on the number of common shingles. Similar pages, either structurally or by content, share respective shingles. Pruning based on the number of common shingles controls the homogeneity of the clusters.

To merge nodes, the nodes, along with their sub-trees, are merged into a single merged cluster node. The information of the merged nodes and their respective sub-trees are aggregated at the merged node level. The sub-tree under the merged node is discarded.

### Storing the Hierarchical Organization

In an embodiment, the hierarchical organization is stored as a suffix tree index or prefix tree index. Both of these data structures allow for the fast implementation of string operations. Cluster names and tokens are stored in a prefix tree to allow linear time mapping of URLs to clusters. A cluster name is made up of the following components: (1) host name, (2) path, (3) script, and (4) key-value pairs. The static component of a URL comprises the host name, path, and script. The dynamic component comprises the key-value pairs consistent with parameters.

In an embodiment, an unknown URL is tokenized into these components and matched to the prefix tree. The nodes of the prefix tree contain additional meta-information corresponding to all URLs that match. The result of matching is a normalized, or converted, URL and meta-information.

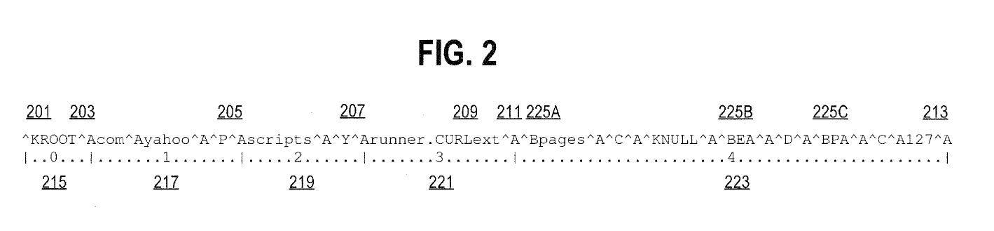

In an embodiment, a cluster name represents a set of URLs based on positive patterns for the host name, path, and script. A combination of positive and negative patterns may be used for the keys and values of the parameters. The set of all cluster names for a domain have a tree structure. An example of a cluster name is shown in FIG. 2.

The numbers below the cluster name 201 indicate the different components of the cluster name. In FIG. 2, “0” 215 represents the start marker, “1” 217 is the host name, “2” 219 is the path, “3” 221 is the script name, and “4” 223 shows the key-value pairs. In an embodiment, some of these components are comprised of sub-components. For example, under the component for host-name may be the domain and sub-domain. Under the component for path is sequence of directories and file-names. For key-value pairs, the sub-components are the key, the presence/absence indicator for value, and the value.

In an embodiment, certain symbols indicate certain meanings or mark the end of a component. For example in FIG. 2, each sub-component or component may be terminated by a “̂A” character 203, 205, 207, 211, and 213. The end of the host-name may be indicated by “̂P̂A” 205. In one embodiment, the suffix of the script name, such as “.php” or “.asp,” is replaced by “.CURLext” 209. A “̂ÊA” pattern in any of the components of the static URL indicates that the exact string which occurs in that particular level does not matter. Thus, if a “̂ÊA” is present, then any string is considered to match until the next “̂A” is encountered. The presence of “̂ÊÊA” means that all tokens up to the end of the URL or the start of the script name, whichever comes first, are to be ignored. In an embodiment, sub-trees containing dynamic scripts are separated from sub-trees not containing dynamic scripts. In FIG. 2, the label “̂Y” 207 indicates that a dynamic script name, “runner. CURLext” follows immediately.

In an embodiment, the key-value pair component is an ordered list of keys. In the key-value pair component, the presence or absence of each key in a URL is indicated. For every key that is present, the corresponding value for that key is stored. In addition, the value may be indicated to not matter. As shown in FIG. 2, “̂B” 225A, 225B, and 225C indicate the start of a key-value pair.

In an embodiment, key-value patterns may be represented as:
1. ̂Bk1̂ÂD̂A key “k1” does not occur in the URLs
2. ̂Bk1̂ÂĈAv1̂A key “k1” occurs in the URLs with value “v1”
3. ̂Bk1̂ÂĈÂÊA key “k1” occurs in the URLs and the exact form of the value does not matter.

In the first pattern, “̂B” indicates the start of the key-value and the key is “k1.” “̂A” indicates the end of the key sub-component. “̂D” indicates that this particular key does not occur in the URLs. The value sub-component is terminated with “̂A.” In the second pattern, “̂B” indicates the start of the key-value and the key is “k1.” “̂A” indicates the end of the key sub-component. “̂ĈA” indicates that a value for this particular key does occur and that value is “v1.” In the third pattern, the key is “k1.” “̂ĈÂE” indicates that a value occurs for key “k1” but that the exact form of the value does not matter. These sequences of patterns occur at the end of the cluster name if the cluster name has patterns for key-value pairs.

### Matching

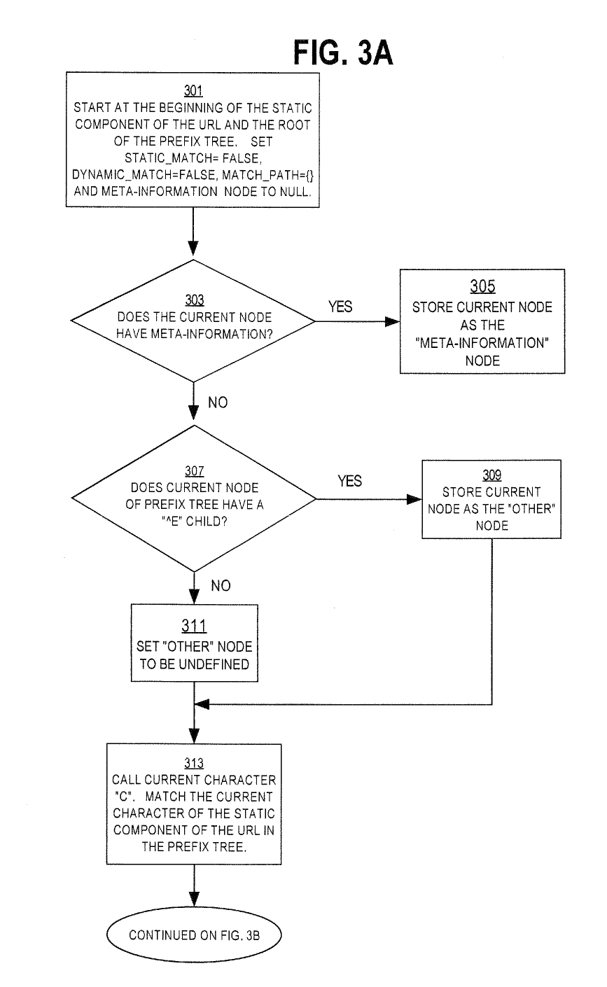

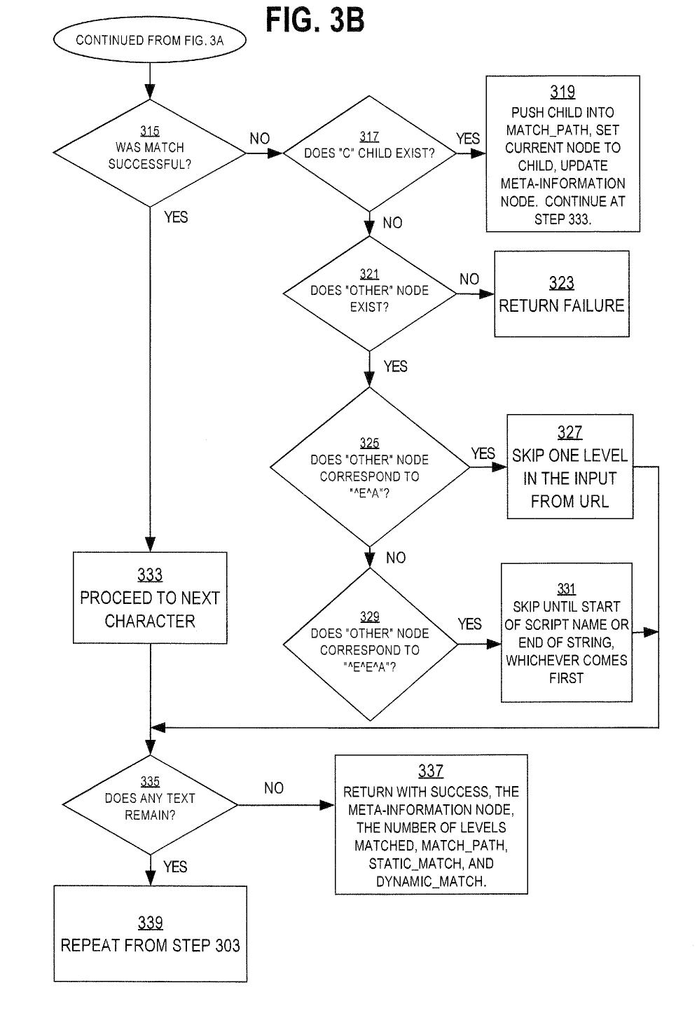

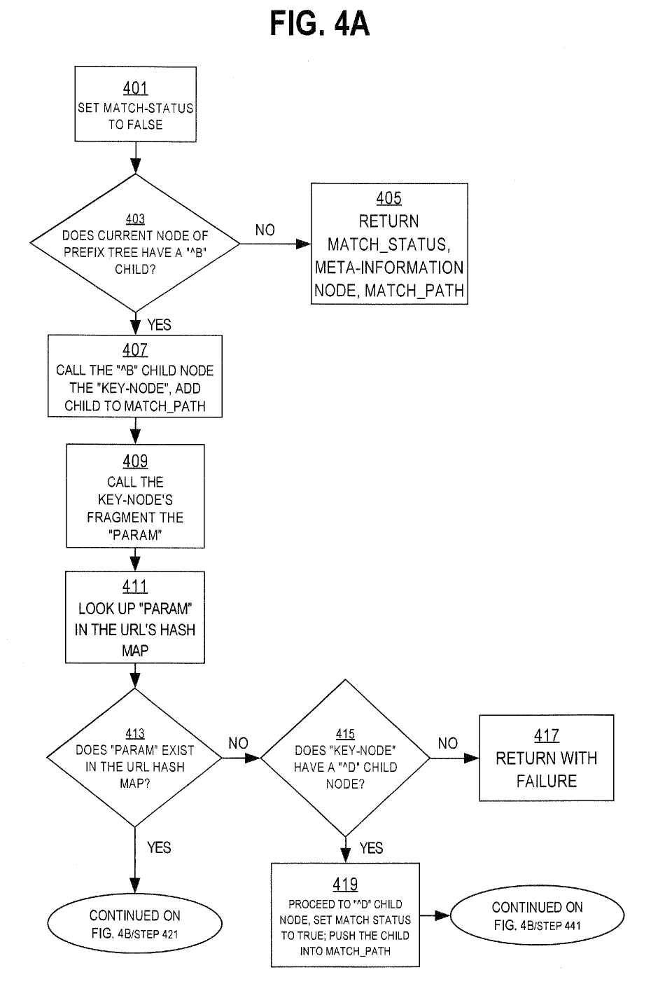

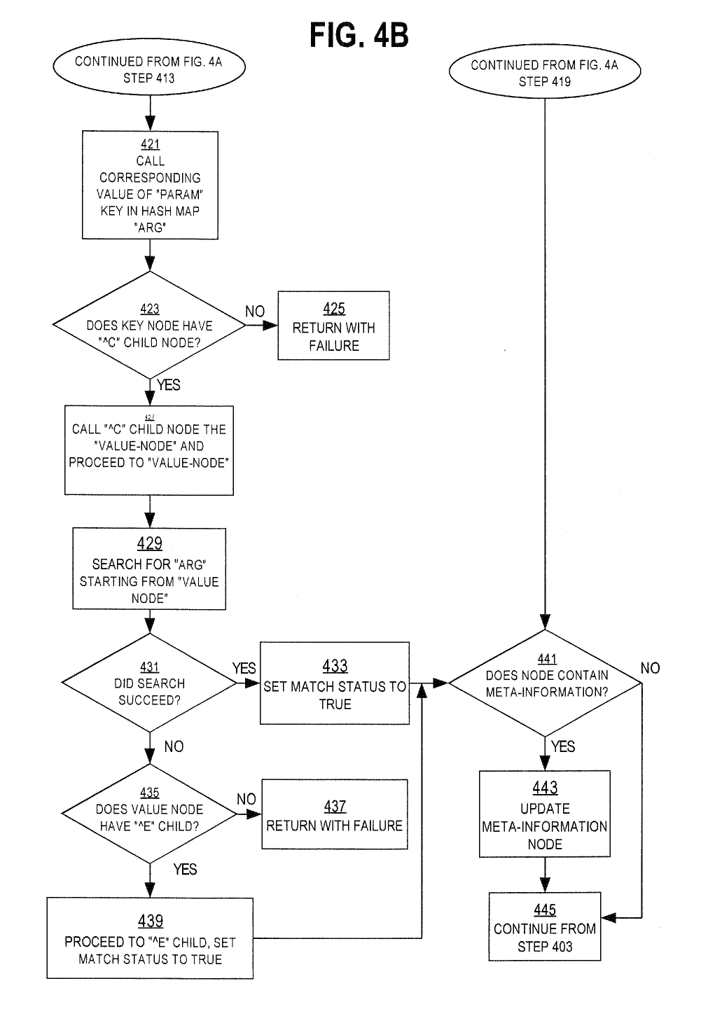

In an embodiment, when a URL is received, the URL is matched to the prefix tree with a static-match algorithm, as shown in FIG. 3A and 3B, followed by a dynamic-match algorithm, as shown in FIG. 4A and 4B. Other matching algorithms may be used based upon the data structure of the hierarchical organization and this may vary from implementation to implementation. First, the URL is partitioned into static components and dynamic components. The static components comprise the (a) host and path or (b) host, path, and script name. The dynamic components comprise a hash map of the parameters' key-value pairs.

As used herein, a “hash map” is a data structure that associates keys with values. When given a particular key, a hash map is able to locate and return the corresponding value for that particular key. A hash map is generated by first transforming the key using a hash function into a hash. The hash is a number that is then used to index into an array, the locations of the desired values. For example, consider the URL with dynamic parameters “cat=‘electronics’” and “product_id=‘13.’” The key for the first parameter is “cat” and the value is “electronics.” The key for the second parameter is “product_id” and the value is “13.” If the key, “cat,” is sent to the hash map, then the hash map would return the value for “cat” which is “electronics.” If the key, “product_id,” is sent to the hash map, then the hash map would return the value for “product_id” which is “13.” In an embodiment, the hash map may return whether a particular key exists within the hash map. In another embodiment, the hash map may return that though a particular key does exist, no value is associated with that particular key.

The prefix tree is made up of prefix tree nodes. Each node has children corresponding to some characters. The child node corresponding to a particular character, such as “x,” is referred to as the “x”-child of that parent node. Each node also has a string, though the string may be empty, referred to herein as the “fragment” of that particular node.

The steps for static matching are shown in FIGS. 3A and 3B. In an embodiment, the static-match algorithm begins by examining the beginning of the static component of the URL at the root of the prefix tree as shown in step 301. Also, in step 301, the variables static_match and dynamic_match are set to false, match_path is set to an empty set, and the meta-information node in set to NULL. In step 303, the current node is checked to see if meta-information is present. If meta-information is present, then the information is updated in the “meta-information-node” as shown in step 305. Otherwise, in step 307, a determination is made as to whether the particular prefix tree node has a “̂E” child node, indicating that the prefix tree has a static component where the string does not matter. If a “̂E” child is present, then in step 309, the particular node is stored as the “other” node. If the current node does not have a “̂E” child node, then the “other” node is set as undefined as seen in step 311.

In step 313, an attempt to match (a) the current character in the static component of the URL to (b) a node in the prefix tree is made. In addition, the current character is renamed to the “C” character. In step 315, the success of the match is determined. If a match cannot be made then, in step 317, a determination is made as to whether a “C” child exists. If the “C” child exists, then push the child into match_path, set the current node to the child node, and update the meta-information node. Finally, continue the algorithm at step 333. If no “C” child exists, then in step 321, a determination is made as to whether a valid “other” node exists. As stated above, an “other” node is stored when there is an “̂E” child that indicates that the string does not matter. Thus, if no “other” node exists, then in step 323, static-match returns a failure as shown. In step 325, a determination is made as to whether the “other” node corresponds to “̂ÊA.” If the “other” node exists and corresponds to “̂ÊA,” indicating that the exact string which occurs in this level does not matter, then, as shown in step 327, one level in the input URL is skipped by going to the next “̂A,” indicating the end of the level. In step 329, a determination is made as to whether the “other” node corresponds to “̂ÊÊA”. If the “other” node exists and corresponds to “̂ÊÊA,” then in step 331, the URL is traversed until the start of script-name or the end of string, whichever comes first.

If the match for the current character was successful, then in step 333, the URL is traversed to the next character. In step 335, a determination is made as to whether any text remains in the static component of the URL in which to match. If no more characters in the input URL remain, then the end of the static component has been reached. As shown in step 337, a “success” indication, the meta-information node, the number of levels that matched, the match_path, static_match, and dynamic_match are returned. If text does still remain, then in step 339, the algorithm is continued from step 303.

If the static-match succeeds, then dynamic-match is initiated in the prefix tree beginning in the node where the static-match algorithm terminated. The dynamic match algorithm is shown in FIGS. 4A and 4B. Dynamic match begins with step 401 where “match-status” is set to “false.” In step 403, the current prefix tree node, which in the first iteration of this algorithm is where the static match ended, is examined to see whether the current node has a “̂B” child. If there is no “̂B” child, then, as shown in step 405, the current match-status is returned. If the current node does have a “̂B” child, then, as shown in step 409, the “̂B” child node is called the “key-node.” In step 409, the key-node's fragment is given the name “param.” As stated earlier, a node's fragment is the string, which may be null, that is associated with that particular node. Thus in step 409, the string associated with the “key-node” is called “param.” In step 411, the “param” string is searched within the URL's hash-map. In step 413, a determination is made as to whether the “param” string exists in the URL hash map.

If the “param” string is found not to exist in the hash-map, then in step 415, a search is made for a “̂D” child of the “key-node.” A “̂D” child indicates that the parameter key does not occur, as shown with the patterns for parameters above, and thus is unnecessary according to the prefix tree. If the “̂D” child exists, then in step 419, a traverse is made to the “̂D” child node, match_status is set to “true,” and the cild node is pushed into the match_path. Then the algorithm is continued by proceeding to step 441. If such a “̂D” child is found not to exist, then the match status of “failure” is returned.

If the “param” key exists in the hash-map, then in step 421, the corresponding value to the parameter is called in the hash-map and the resulting value is given the name “arg.” In step 423, a determination is made as to whether the “key-node” has a “̂C” child. If such a “̂C” child does not exist, then in step 425, the match status of “failure” is returned. If the “̂C” child does exist, then as shown in step 427, the “̂C” child is named the “value-node” and then a traverse is made to the “value-node.” Then in step 429, the nodes in the prefix tree are searched to attempt to find a node, beginning from the “value-node,” corresponding to the “arg” value from the URL hash map. In step 431, a determination is made as to whether the search is successful. If the search succeeds, then as shown in step 433, the match-status is set to “true,” and the dynamic match algorithm is continued by proceeding to step 441. If the search did not succeed, then as shown in step 435, the “value-node” is searched to determine whether the “value-node” has an “̂E” child. If an “̂E” child is not found, then, as shown in step 437, the match status of “failure” is returned. If the “value-node” does have an “̂E” child, then a traverse is made to the “̂E” child and the match-status is set to “true.” The dynamic match algorithm is then continued by proceeding to step 441.

In step 441, a determination is made as to whether the code contains meta-information. If the node does contain meta-information, then the meta-information node is updated in step 443 and then continues to step 445. If the node does not contain meta-information, then in step 445, the dynamic match algorithm is continued from step 403.

### Overview of Normalizing URLS

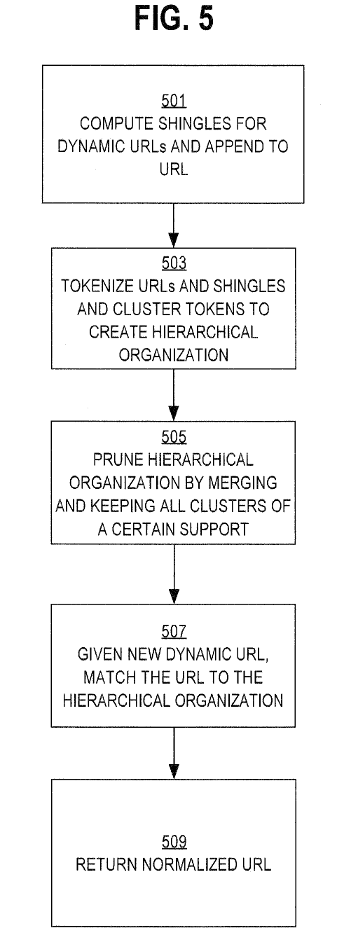

FIG. 5 shows an overview of the steps to normalize URLs based upon a hierarchical organization of a website, according to an embodiment. In step 501, the fingerprints or shingles, of the URLs are computed and appended to the corresponding URL. Next, as shown in step 503, the appended URLs with the shingles are tokenized and then the tokens are clustered into a hierarchical structure, such as a prefix tree or a suffix tree. In step 505, in order to reduce the memory requirements and increase the speed of searches, the site map, or hierarchical organization, is pruned by merging nodes and removing all clusters that do not reach a specified level of support. In step 507, a new URL is received and is matched to the hierarchical organization. Finally, in step 509, once the URL is matched, the URL is returned with irrelevant parameters removed and higher priority parameters in order. The modified URL that is returned is the normalized URL.

### Example of Normalizing URLS

To better describe the technique of normalizing URLs, an example of the site “http://games.nuclearcentury.com” is presented. This web site has games organized by the parameters “category,” “id,” and “reviews.” A set of sample URLs from the site is as follows:

http://games.nuclearcentury.com/full.php?id=6186
http://games.nuclearcentury.com/full.php?id=6187
http://games.nuclearcentury.com/full.php?id=6188
http://games.nuclearcentury.com/index.php
http://games.nuclearcentury.com/index.php?act=Arcade&do=newscore
http://games.nuclearcentury.com/index.php?action=category&id=%3C?=
3?%3E&page=0
http://games.nuclearcentury.com/index.php?action=category&id=%3C?=
7?%3E&page=0
http://games.nuclearcentury.com/index.php?action=category&id=&page=
0&order2=gId&sby=DESC&submit=Go
http://games.nuclearcentury.com/index.php?action=category&id=&page=
0&order2=gName&sby=ASC&submit=Go
http://games.nuclearcentury.com/index.php?action=category&id=1&page=
0&order2=game_name&sby=ASC
http://games.nuclearcentury.com/index.php?action=category&id=1&page=
0&ppage=20&order2=game_name&sby=ASC
http://games.nuclearcentury.com/index.php?action=category&id=1&page=
1&order2=game_name&sby=ASC
http://games.nuclearcentury.com/index.php?action=category&id=1&page=
10&order2=game_name&sby=ASC
http://games.nuclearcentury.com/index.php?action=category&id=1&page=
12&order2=game_name&sby=ASC
http://games.nuclearcentury.com/index.php?id=4397&action=play
http://games.nuclearcentury.com/index.php?action=play&id=4398
http://games.nuclearcentury.com/index.php?action=play&id=4399
http://games.nuclearcentury.com/index.php?action=play&id=4417
http://games.nuclearcentury.com/index.php?id=4419&action=play
http://games.nuclearcentury.com/index.php?action=play&id=4420
http://games.nuclearcentury.com/index.php?action=play&id=4421
http://games.nuclearcentury.com/index.php?action=play&id=4423
http://games.nuclearcentury.com/index.php?action=play&id=4424

Shingles are calculated based on the techniques described above. The shingles for a particular web page are then appended to the URL of that particular web page as parameters and values. For example, given the following URL: http://games.nuclearcentury.com/index.php?action=play&id=4424

The shingles are generated and then appended to the URL to create:

http://games.nuclearcentury.com/index.php?action=play&id=4424&sh1=
0e&sh2=a1&sh3=e0&sh4=00&sh5=82&sh6=10&sh7=ff&sh8=c53a

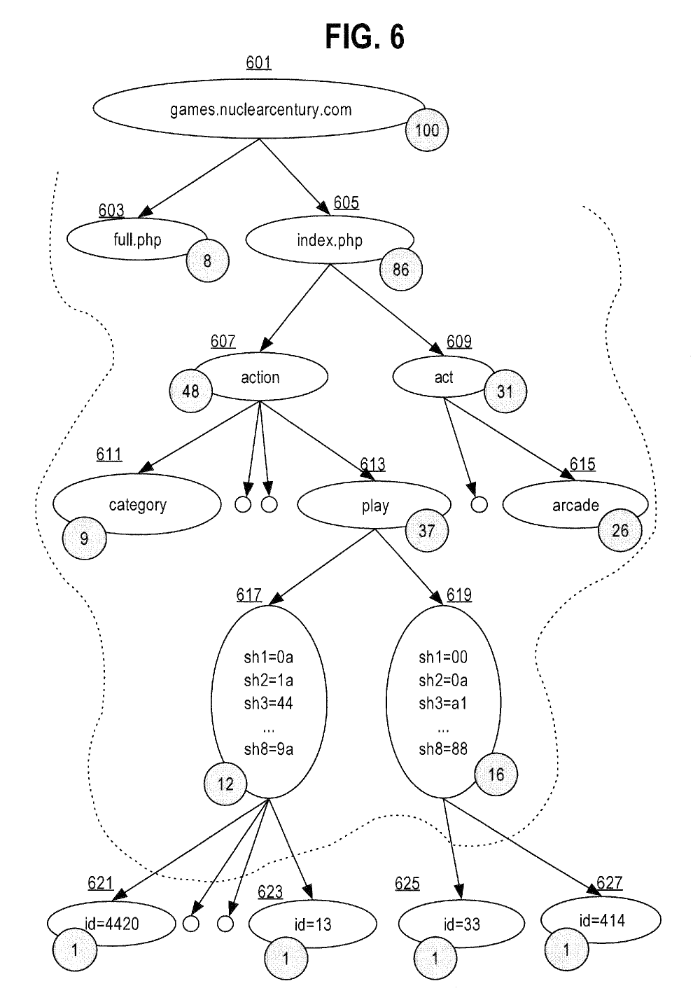

FIG. 6 is an illustration showing a hierarchical organization generated after clustering the URLs from the domain “games.nuclearcentury.com” after appending the structural and content shingles. The domain “games.nuclearcentury.com” 601 is at the root of the hierarchical organization and is associated with 100 URLs as shown in the small grey circle connected to the node. On the next level is “full.php” 603 and “index.php” 605, which are script names. One level below the script names are the parameter keys. “Action” 607 is associated with 48 URLs and “act” 609 is associated with 31 URLs. A level below are values of the parameters, with “category” 611, “play” 613, and “arcade” 615. Next are the shingle nodes at 617 and 619. These shingle nodes are grouped together as a single node rather than keeping each shingle separate. The shingle nodes may be grouped based on a specified number of matching shingles. Below the shingles are parameters that are not relevant. They are “id=4420” 621, “id=13” 623, “id=33” 625, and “id=414” 627. These parameters are only associated with a single URL and so the parameters do not meet the necessary support level of at least 8 URLs (according to one embodiment). Thus, these nodes would be pruned. In addition, the FIG. 6 displays a dotted line indicating a support border. Any node located outside of the dotted line is removed.

Because the shingles group all similar pages together, the normalization of URLs may occur. For example, the URLs “http://games.nuclearcentury.com/index.php?action=play&id=4420” and “http://games.nuclearcentury.com/index.php?id=13&action=play” might be normalized with “action=play” being more important than the parameters “id=4420” and “id=13.” In addition, these URLs are similar because they belong to the same shingle node.

From the hierarchical organization, irrelevant parameters may be determined, such as “page=,” and “order2=,” and “by=,” for URLs that also have the parameter “action=category.” Because these parameters are unimportant to the content or structure of the web pages, URLs may be normalized to remove these parameters.

### Hardware Overview

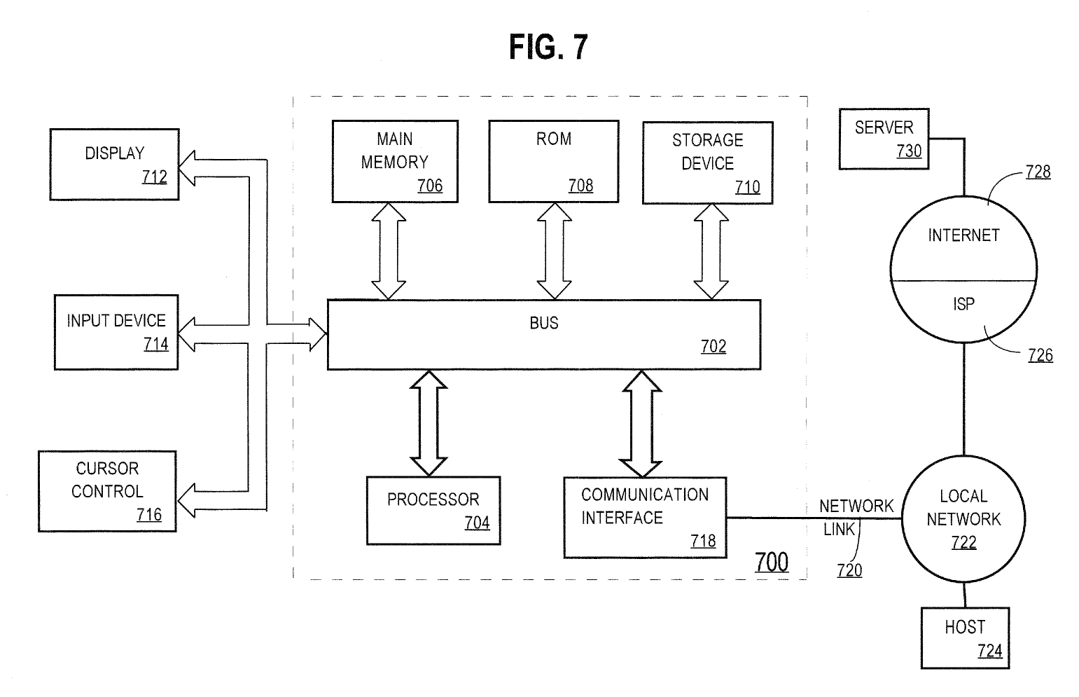

FIG. 7 is a block diagram that illustrates a computer system 700 upon which an embodiment of the invention may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

The invention is related to the use of computer system 700 for implementing the techniques described herein. According to one embodiment of the invention, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 700, various machine-readable media are involved, for example, in providing instructions to processor 704 for execution. Such a medium may take many forms, including but not limited to storage media and transmission media. Storage media includes both non-volatile media and volatile media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution. In this manner, computer system 700 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method for converting a dynamic URL, comprising:
generating, for each particular web page of a plurality of web pages, one or more data structures that represent the particular web page;
tokenizing URLs of each of the plurality of web pages into first components;
clustering (a) the first components and (b) the data structures into a hierarchical organization;
receiving a subsequent URL that contains information that does not affect content of a web page to which the subsequent URL refers;
tokenizing the subsequent URL into second components;
matching the second components to an entry in the hierarchical organization;
generating, based upon the matching, a converted URL that lacks the information; and
returning the converted URL.

2. The method of claim 1, wherein clustering further comprises pruning the hierarchical organization to a specified level.

3. The method of claim 1, wherein generating the data structures comprises generating the data structures based upon a complete HTML structure of the web page.

4. The method of claim 1, wherein generating the data structures comprises generating the data structures based upon a de-tagged text of HTML of the web page.

5. The method of claim 1, wherein generating the data structures comprises generating the data structures based upon distinct text of HTML of the web page.

6. The method of claim 1, wherein generating the data structures further comprises computing shingles using a hash function.

7. The method of claim 1, wherein the data structures comprise shingles.

8. The method of claim 1, wherein the hierarchical organization is a prefix tree.

9. The method of claim 1, wherein the hierarchical organization is a suffix tree index.

10. The method of claim 1, wherein matching further comprises matching the static component of the URL and the dynamic component of the URL to the hierarchical organization.

11. The method of claim 1, wherein clustering the data structures further comprises matching a specified number of the data structures.

12. The method of claim 11, wherein matching a specified number of the data structures further comprises masking one or more of the data structures.

13. The method of claim 1, wherein clustering the first components further comprises merging siblings of the hierarchical organization.

14. The method of claim 1, wherein clustering the first components further comprises merging nodes of the hierarchical organization with similar HTML content.

15. The method of claim 1, wherein clustering the data structures further comprises merging nodes of the hierarchical organization with similar structure.

16. A method for converting a URL, comprising:
generating, for each particular web page of a plurality of web pages, one or more data structures that represent the particular web page;
tokenizing URLs of each of the plurality of web pages into first components;
clustering (a) the first components and (b) the data structures into a hierarchical organization;
receiving a subsequent URL that contains information that does not affect content of a web page to which the subsequent URL refers;
tokenizing the subsequent URL into second components;
matching the second components to an entry in the hierarchical organization;
generating, based upon the matching, a converted URL that lacks the information; and
returning the converted URL.

17-32. (canceled)
